(19) United States
(12) Patent Application Publication
(10) Pub. No.: US 2026/0302262 A1
(43) Pub. Date: Oct. 1, 2026

(54) SECONDARY BATTERY

(71) Applicant: SAMSUNG SDI CO., LTD., Yongin-si (KR)

(72) Inventor: Da Mi CHEON, Yongin-si (KR)

(21) Appl. No.: 19/302,219

(22) Filed: Aug. 18, 2025

(30) Foreign Application Priority Data
Mar. 31, 2025 (KR) 10-2025-0040845

(51) Int. Cl. H01M 4/75; H01M 4/13; H01M 50/55; H01M 50/553; H01M 50/586; H01M 50/593

(52) U.S. Cl. CPC H01M 4/75; H01M 4/13; H01M 50/55; H01M 50/553; H01M 50/586; H01M 50/593

(57) ABSTRACT

A secondary battery includes a case and an electrode assembly accommodated in the case. The electrode assembly includes a plurality of first electrode plates, separators, and a plurality of second electrode plates. Each of the first electrode plates includes an electrode current collector including an electrode insulating layer, an electrode metal layer provided on the electrode insulating layer, and an electrode tab protruding in a first direction from a side of the first electrode current collector, and an electrode active material provided on the first electrode current collector. The electrode tabs are uncoated areas of the electrode current collectors of the first electrode plates that are not coated with the first electrode active material. A connection member extends through the electrode tabs.

### CROSS-REFERENCE TO THE RELATED APPLICATION

The present application claims priority to and the benefit of Korean Patent Application No. 10-2025-0040845, filed on Mar. 31, 2025, in the Korean Intellectual Property Office, the entire disclosure of which is incorporated herein by reference.

### BACKGROUND

### 1. Field

The present disclosure relates to a secondary battery.

### 2. Description of the Related Art

Unlike a primary battery, a secondary battery may be charged and discharged. Low-capacity secondary batteries having a single battery cell packaged in the form of a pack are widely employed in small, portable electronic devices, such as smart phones, feature phones, laptop computers, digital cameras, camcorders, and the like, while large-capacity secondary batteries are widely used as power sources for driving motors in hybrid vehicles, electric vehicles, and the like, as well as batteries for power storage. The secondary battery includes an electrode assembly consisting of a positive electrode and a negative electrode, a case that accommodates the electrode assembly, and electrode terminals connected to the electrode assembly.

The above information disclosed in this Background section is only for enhancement of understanding of the background of the invention and therefore it may contain information that does not constitute prior art.

### SUMMARY

The present disclosure provides a secondary battery in which an insulating layer is embedded in an electrode current collector of an electrode plate, thereby reducing the overall thickness and weight of the electrode plate and improving specific energy. The present disclosure also provides a secondary battery in which a connection member penetrates and secures a plurality of aligned electrode tabs, thereby enabling current flow through the electrode tabs and facilitating welding and joining of the electrode tabs.

However, the technical problems to be achieved in the embodiment of the disclosure are not limited to the technical problems mentioned above, and other technical problems not mentioned herein will be clearly understood from the following description by those skilled in the art to which the disclosure belongs.

A secondary battery according to an embodiment of the present disclosure includes a case and an electrode assembly accommodated in the case, the electrode assembly includes a plurality of first electrode plates, separators, and second electrode plates, with the first electrode plates and the second electrode plates being alternatively stack and one of the separators being positioned between each pair of first electrode plate and second electrode plate. Each of the first electrode plates includes a first electrode current collector, including a first electrode insulating layer having a plate shape, a first electrode metal layer provided on opposite surfaces of the first electrode insulating layer, and a first electrode tab protruding in a first direction from a side of the first electrode current collector, and a first electrode active material provided on least one surface of the first electrode current collector. The first electrode tabs are areas of the first electrode current collectors that are not coated with the first electrode active material, the first electrode tabs are aligned with each other in a second direction that is perpendicular to the first direction, and a first connection member extends through the first electrode tabs.

According to some embodiments, the first connection member may penetrate the first electrode tabs from an upper surface of an uppermost first electrode tab to a lower surface of a lowermost first electrode tab, and at least a portion of the first connection member may be secured to the lower surface of the lowermost first electrode tab.

According to some embodiments, the first connection member may have a C-shaped clip structure.

According to some embodiments, the first connection member may include a first region located on the upper surface of the uppermost first electrode tab, a second region that is bent from the first region and extends from opposite sides of the first region, with the second region extending through the first electrode tabs in the second direction, and a third region that is bent and extends from the second region, with the third region being positioned on the lower surface of the lowermost first electrode tab.

According to some embodiments, the third region may be in contact with the lower surface of the lowermost first electrode tab.

According to some embodiments, the third region may be bent toward the center of the first connection member.

According to some embodiments, the first region may have a linear shape extending in a third direction that is perpendicular to the first direction and the second direction.

According to some embodiments, the first region may have a linear shape extending in the first direction.

According to some embodiments, the first region, the second region, and the third region may each have a thickness ranging from 0.2 mm to 0.5 mm.

According to some embodiments, the first region, the second region, and the third region may have different thicknesses.

According to some embodiments, the first connection member may be positioned in a central area of the length of the first electrode tab in the third direction, and peripheral areas of the first electrode tab outside of the central area may have a widths of 1 mm or greater in the third direction.

According to some embodiments, the first connection member may include a plurality of connection members, and the connection members may be arranged in the first direction.

According to some embodiments, the first connection member may include a plurality of connection members, and the connection members may be arranged in the third direction.

According to some embodiments, the first connection member may be formed of at least one of nickel, copper, stainless steel, and silver.

According to some embodiments, the first electrode metal layer, the first electrode active material, and the first electrode insulating layer may be exposed at opposite sides of the first electrode plate.

According to some embodiments, the first electrode insulating layer may include at least one of polyimide (PI), polyethylene terephthalate (PET), polypropylene (PP), polyethylene (PE), polystyrene (PS), acrylonitrile butadiene styrene (ABS), polyoxymethylene (POM), polyvinyl chloride (PVC), polycarbonate (PC), polycaprolactone (PCL), polylactic acid (PLA), acrylic resin, polybutylene terephthalate (PBT), celluloid, polytetrafluoroethylene (PTFE), Bakelite, epoxy, melamine-formaldehyde, amino, and phenol-formaldehyde.

According to some embodiments, the secondary battery may further include a cover member configured to cover at least one of the first region or the third region of the first connection member.

According to some embodiments, each of the second electrode plates may include a second electrode current collector, including a second electrode tab extending and protruding in the first direction from a side of the second electrode current collector, and a second electrode active material provided on at least one surface of the second electrode current collector. The second electrode tabs may be areas of the second electrode current collectors that are not coated with the second electrode active material, and the first electrode tabs are spaced apart and electrically isolated from the second electrode tabs.

According to some embodiments, each of the second electrode plates may include a second electrode current collector, formed as a plate-shaped metal foil and including a second electrode tab protruding in the first direction from a side of the second electrode current collector, and a second electrode active material provided on at least one surface of the second electrode current collector. The second electrode tabs may be uncoated areas of the second electrode current collectors that are not coated with the second electrode active material, the second electrode tabs may be aligned with each other in the second direction, and the second electrode tabs may be welded to each other.

According to some embodiments, each of the second electrode plates may include a second electrode current collector, including a second electrode insulating layer having a plate shape, a second electrode metal layer provided on opposite surfaces of the second electrode insulating layer, and a second electrode tab protruding in the first direction from one side of the second electrode current collector, and a second electrode active material provided on at least one surface of the second electrode current collector. The second electrode tabs may be areas of the second electrode current collectors that are not coated with the second electrode active material, the second electrode tabs may be aligned with each other in the second direction, and a second connection member may extend through the second electrode tabs.

### BRIEF DESCRIPTION OF THE DRAWINGS

The following drawings attached to this specification illustrate preferred embodiments of the present disclosure and serve to further understand the technical idea of the present disclosure together with the detailed description of the present disclosure. The present disclosure should not be construed as being limited to the matters described in such drawings.

FIG. 1 is a perspective view of a secondary battery according to the present disclosure;

FIG. 2 is an exploded perspective view of the secondary battery according to the present disclosure;

FIG. 3 is a plan view of an electrode assembly of the secondary battery shown in FIG. 2;

FIG. 4 is a schematic cross-sectional view of the electrode assembly taken along line 4-4′ in FIG. 3;

FIG. 5 is an exploded perspective view of a state before blanking of a negative electrode plate of the electrode assembly in FIG. 3;

FIG. 6 is a schematic cross-sectional view of an example of a negative electrode tab of the electrode assembly taken along line 6-6′ in FIG. 3;

FIG. 7 is a schematic cross-sectional view of an example of a positive electrode tab of the electrode assembly taken along line 7-7′ in FIG. 3;

FIG. 8 is a plan view of a first embodiment of the negative electrode tab shown in FIG. 6;

FIG. 9 is a plan view of a second embodiment of the negative electrode tab shown in FIG. 6;

FIG. 10 is a plan view of a third embodiment of the negative electrode tab shown in FIG. 6;

FIG. 11 is a plan view of a fourth embodiment of the negative electrode tab shown in FIG. 6;

FIG. 12 is a view schematically showing a smartphone equipped with a secondary battery pack according to an embodiment of the present disclosure;

FIGS. 13 and 14 illustrate perspective views of an example of a battery pack; and

FIGS. 15 and 16 illustrate perspective and side views of examples of a vehicle body and vehicle components.

### DETAILED DESCRIPTION OF EXEMPLARY EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way. Therefore, the embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application. In addition, it will be understood that the terms “comprise or include” and/or “comprising or including,” when used in this specification, specify the presence of stated features, integers, steps, operations, elements, and/or components but do not preclude the presence or addition of one or more other features, integers, steps, operations, elements, components, and/or groups thereof. In addition, when describing embodiments of the present disclosure, the wording “may ~” or “may be~” may include “one or more embodiments of the present disclosure.”

In addition, for a better understanding of the invention, the attached drawings are not drawn to scale and the dimensions of some components may be exaggerated. In addition, the same reference numbers may be assigned to the same components in different embodiments.

A reference to two objects in comparison being the same means that they are substantially the same. Thus, the wording “substantially the same” may include cases where the same is considered to be a low level in the related art, for example, a deviation within 5%. In addition, when any of parameters is referred to as being uniform in a given region, it may mean that the parameter is uniform from an average perspective.

It will be understood that, although the terms “first,” “second,” etc., may be used herein to describe various components, these components should not be limited by these terms. These terms are used to distinguish one component from another component. Thus, unless otherwise defined, a first component described below could be termed a second component, without departing from the spirit and scope of the present disclosure.

Throughout the specification, the singular forms are intended to include the plural forms as well, unless the context clearly indicates otherwise.

The arrangement of an arbitrary component on the “upper portion (or lower portion)” or “upper (or lower)” of a component means that an arbitrary component is placed in contact with the upper (or lower) surface of the component. In addition, it may mean that other components may be interposed between the component and any component disposed on (or under) the component.

Also, it will be understood that when an element is referred to as being “coupled to,” “linked to,” or “connected to” another element, these elements can be directly coupled or connected to each other, another intervening element may be present therebetween, or the respective elements may be coupled, linked, or connected to each other through another elements. In addition, it will be understood that when an element is referred to as being electrically coupled to another element, the element can be directly connected to another element or an intervening element may be present therebetween such that the element and another element are indirectly connected to each other.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

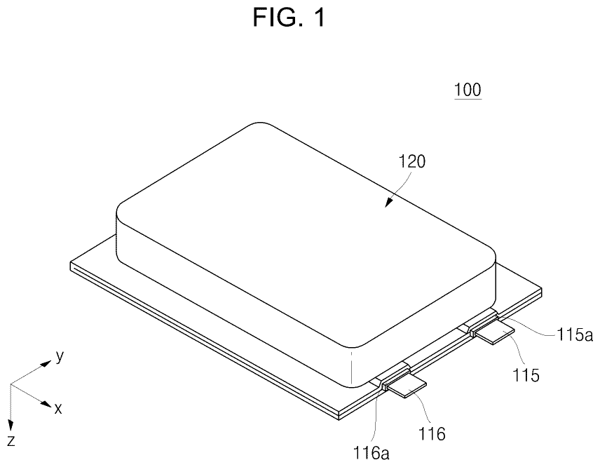

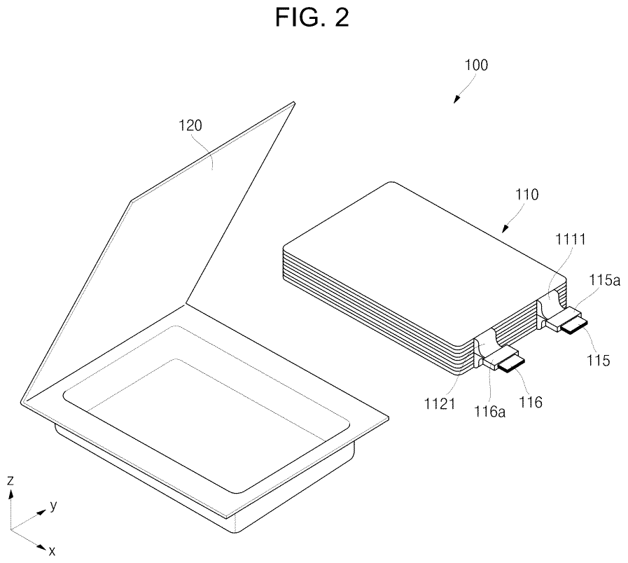

FIG. 1 is a perspective view of a secondary battery according to the present disclosure, and FIG. 2 is an exploded perspective view of the secondary battery according to the present disclosure.

As shown in FIGS. 1 and 2, the secondary battery 100 according to the present disclosure includes an electrode assembly 110 and a case 120 accommodating the electrode assembly 110. The electrode assembly 110 is accommodated in the case 120 together with an electrolyte (not shown).

The case 120 may include a pouch body and a pouch cover, which may be formed by folding a rectangular pouch film in a first direction x corresponding to the longitudinal direction of the pouch film. In this case 120, the electrode assembly 110 may be accommodated in an accommodation portion defined in the pouch body, and the pouch cover may be folded and coupled to the pouch body in a sealed state.

Although the case 120 in FIGS. 1 and 2 is illustrated as a pouch type, the case 120 may be configured as a prismatic or cylindrical type. In other embodiments where the case 120 is prismatic or cylindrical, the electrode assembly 110 may be accommodated in the case 120, and a cap assembly may be coupled to the case to seal the case. Thus, the present disclosure is not limited to the depicted pouch-type case 120.

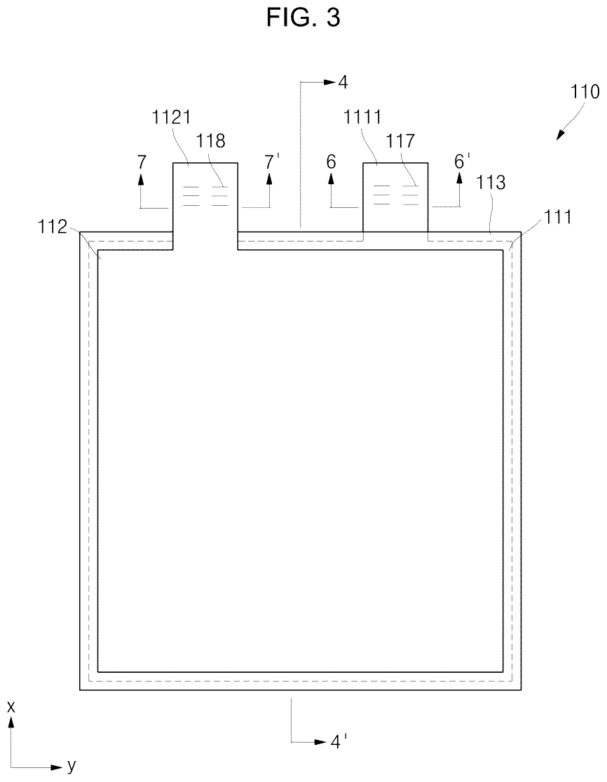

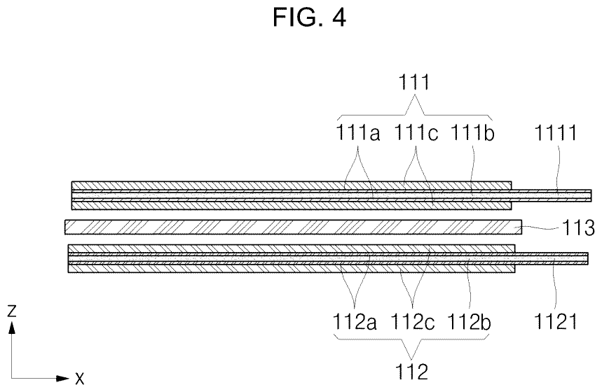

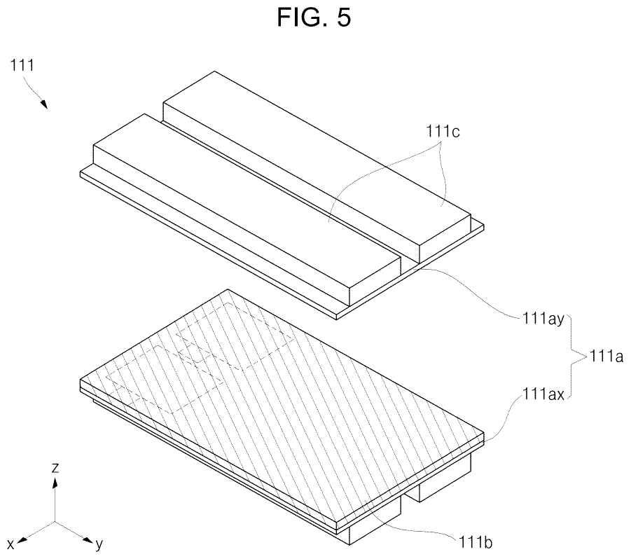

FIG. 3 is a plan view of the electrode assembly of the secondary battery shown in FIG. 2, FIG. 4 is a schematic cross-sectional view of an example of the electrode assembly taken along line 4-4′ in FIG. 3, and FIG. 5 is an exploded perspective view of a state before blanking of a negative electrode plate of the electrode assembly in FIG. 3. Hereinafter, the electrode assembly of the present disclosure will be described with reference to FIGS. 2 to 5. In some embodiments, as schematically shown in FIGS. 4 and 5, the electrode assembly may include one first electrode plate 111, one separator 113, and one second electrode plate 112, which are spaced apart from one another. However, in practice, a plurality of first electrode plates 111, a plurality of separators 113, and a plurality of second electrode plates 112 may be alternately stacked in the order of the first electrode plate 111, the separator 113, the second electrode plate 112, and the separator 113.

The electrode assembly 110 may be formed by sequentially stacking the first electrode plate 111, the separator 113, the second electrode plate 112, and the separator 113. In some embodiments, the first electrode plate 111 may operate with a first polarity, for example, as a negative electrode, and the second electrode plate 112 may operate with a second polarity, for example, as a positive electrode. The electrode assembly 110 may include, or may alternatively be referred to as, an electrode group, an electrode body, or a jelly roll. In some embodiments, the electrode assembly 110 may be formed by winding the first electrode plate 111, the separator 113, the second electrode plate 112, and the separator 113, stacked one above another, into a jelly roll shape. Hereinafter, an example in which the electrode assembly 110 has a stacked structure will be described, but the present disclosure is not limited to this configuration.

The first electrode plate 111 may be formed by applying a first electrode active material 111c, such as a transition metal oxide, to a first electrode current collector 111a that is a metal foil, such as a copper or nickel film. The first electrode active material 111c may be formed on one surface or both surfaces of the first electrode current collector 111a. Hereinafter, an example in which the first electrode active material 111c is formed on both surfaces of the first electrode current collector 111a will be described. In some embodiments, the first electrode current collector 111a may include a first electrode tab 1111 protruding outward in the first direction x from a side of the first electrode plate 111 that extends in a second direction y.

The first electrode plate 111 may further include a first electrode insulating layer 111b provided inside the first electrode current collector 111a. The first electrode current collector 111a may be provided to cover opposite surfaces of the first electrode insulating layer 111b. After the first electrode active material 111c is formed on the first electrode current collector 111a, which is a metal foil having the first electrode insulating layer 111b embedded therein, cutting may be performed to separate the first electrode plate 111 into individual first electrode plates 111, each having the first electrode tab 1111. In the depicted embodiment, the second direction y may be a direction in which the first electrode plate 111 extends, and the first direction x may be a width direction of the first electrode plate 111.

Referring to FIG. 5, the first electrode current collector 111a may include two metal layers, namely, a 1-1^{st} electrode metal layer 111ax and a 1-2^{nd} electrode metal layer 111ay, with both of the metal layers extending in the second direction y. In some embodiments, the 1-1^{st} electrode metal layer 111ax, the 1-2^{nd} electrode metal layer 111ay, the first electrode insulating layer 111b, and the first electrode active material 111c may have the same length in the second direction y.

In some embodiments, the 1-2^{nd} electrode metal layer 111ay may be bonded to the 1-1^{st} electrode metal layer 111ax to cover the first electrode insulating layer 111b and the 1-1^{st} electrode metal layer 111ax. The width of the first electrode insulating layer 111b in the first direction x may be the same as the widths of the 1-1^{st} electrode metal layer 111ax and the 1-2^{nd} electrode metal layer 111ay in the first direction x.

In some examples, the first electrode insulating layer 111b may include at least one of polyimide (PI), polyethylene terephthalate (PET), polypropylene (PP), polyethylene (PE), polystyrene (PS), acrylonitrile butadiene styrene (ABS), polyoxymethylene (POM), polyvinyl chloride (PVC), polycarbonate (PC), polycaprolactone (PCL), polylactic acid (PLA), acrylic resin, polybutylene terephthalate (PBT), celluloid, polytetrafluoroethylene (PTFE), Bakelite, epoxy, melamine-formaldehyde, amino, and phenol-formaldehyde.

The first electrode active material 111c may be provided on one surface or both surfaces of the first electrode metal layer 111a in which the first electrode insulating layer 111b is embedded. In some embodiments, as seen in a plan view the first electrode active material 111c may be provided on at least one surface of the first electrode metal layer 111a to overlap the first electrode insulating layer 111b. The width of the first electrode active material 111c in the first direction x may be equal to or less than the width of the first electrode insulating layer 111b in the first direction x.

In the first electrode plate 111, a first electrode uncoated portion where the first electrode active material 111c is not provided may be located to extend in the second direction y. The first electrode uncoated portion may be spaced apart from one surface of the first electrode active material 111c in the first direction x. The portion of the first electrode plate 111 that is exposed through the first electrode active material 111c may be referred to as the first electrode uncoated portion.

The first electrode plate 111 having the first electrode active material 111c may be separated into individual first electrode plates 111 through a cutting process. In some embodiments, the first electrode tab 1111 of the first electrode plate 111 may protrude in the first direction x.

The first electrode insulating layer 111b may be exposed from a side of each individual first electrode plate 111 that is opposite the side of the first electrode plate 111 at which the first electrode tab 1111 is provided. In some embodiments, the first electrode insulating layer 111b may also be exposed from the side of each individual first electrode plate 111 at which the first electrode tab 1111 is provided.

A plurality of first electrode plates 111 each having the first electrode tab 1111 may be sequentially stacked in a third direction z corresponding to a height direction, with the stack order being the first electrode plate 111, the separator 113, the second electrode plate 112, and the separator 113. In such an example, the first electrode tabs 1111 of the plurality of first electrode plates 111 are stacked and aligned in a line in the height direction z in the electrode assembly 110.

In some embodiments, the plurality of first electrode tabs 1111 may be electrically connected to a single first electrode lead tab 115, and the first electrode tabs 111 may extend and protrude outward from the inside of the case 120. The first electrode lead tab 115 may be formed in a flat plate shape having a larger thickness than the first electrode tabs 1111. In some embodiments, an insulating tape 115a may be interposed between the first electrode lead tab 115 and the case 120. The insulating tape 115a may ensure that an electrically insulated state is maintained between the case 120 and the first electrode lead tab 115.

Because the first electrode insulating layer 111b is embedded in the first electrode metal layer 111a, the first electrode plate 111 may be thin and lightweight, thereby improving specific energy of the secondary battery 100.

The negative electrode active material of the first electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

The second electrode plate 112 may be formed by applying a second electrode active material 112c to a second electrode metal layer 112a that is a metal foil, such as aluminum foil. The second electrode active material 112c may be formed on one or both surfaces of the second electrode metal layer 112a. Hereinafter, an example in which the second electrode active material 112c is formed on both surfaces of the second electrode metal layer 112a will be described. The second electrode plate 112 may further include a second electrode insulating layer 112b provided inside the second electrode metal layer 112a. The second electrode metal layer 112a may be provided to cover one surface or both surfaces of the second electrode insulating layer 112b. After the second electrode active material 112c is formed on the second electrode metal layer 112a, which is a metal foil having the second electrode insulating layer 112b embedded therein, cutting may be performed to separate the second electrode plate 112 into individual second electrode plates 112, with each of the second electrode plates 112 having a second electrode tab 1121. In some embodiments, the second electrode metal layer 112a may include a second electrode tab 1121 protruding outward in the first direction x from a side of the electrode metal layer 112a that extends in the second direction y.

In consideration of a lithium ion precipitation phenomenon that may intermittently occur in the first electrode plate 111 during charging, the second electrode plate 112 may be smaller in the longitudinal direction x and the width direction y than the first electrode plate 111. For example, the first electrode plate 111 may have a larger planar size than the second electrode plate 112. The second electrode tab 1121 may serve as a current path between the second electrode plate 112 and outside of the second electrode.

The shape and structure of the second electrode plate 112 may be to the first electrode plate 111, and, thus, descriptions of features of the second electrode plate 112 that are the same as the first electrode plate 111 will be omitted. However, the position at which the second electrode tab 1121 of the second electrode plate 112 protrudes and is aligned may be different from the position of the first electrode tab 1111. For example, the second electrode tab 1121 may be spaced apart from the first electrode tab 1111 in the second direction y.

Because the second electrode insulating layer 112b is embedded in the second electrode metal layer 112a, the second electrode plate 112 may be thin and lightweight, thereby providing for better specific energy in the secondary battery 100.

The plurality of second electrode tabs 1121 may be electrically connected to a single second electrode lead tab 116, and the second electrode tabs 1121 may extend and protrude outward from the inside of the case 120. The second electrode lead tab 116 may be formed in a flat plate shape that is thicker than the second electrode tabs 1121. An insulating tape 116a may be interposed between the second electrode lead tab 116 and the case 120. The insulating tape 116a may ensure that an electrically insulated state is maintained between the case 120 and the second electrode lead tab 116.

Although the second electrode plate 112 has been described as a composite substrate configured such that an insulating layer is embedded in a metal layer (like the first electrode plate 111), in other embodiments the second electrode plate 112 may not include an insulating layer embedded therein. The second electrode plate 112 may include a second electrode current collector that is formed as a plate-shaped metal foil and has a second electrode tab extending and protruding in the first direction x from a side of the second electrode plate 112 that extends in the second direction y. The second electrode plate 112 may also include a second electrode active material, which covers at least one surface of the second electrode current collector. The second electrode tab may be an uncoated area that is not coated with the second electrode active material. If the second electrode plates are stacked with separator(s) interposed therebetween. In such a configuration, the second electrode tabs may overlap each other in the third direction, which is the height direction, and the second electrode tabs may be welded to each other.

As the positive electrode active material of the second electrode active material 112c, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

As the current collector, aluminum (Al) may be used, but not limited thereto.

The separator 113 may be positioned between the first electrode plate 111 and the second electrode plate 112 to prevent electrical short circuit and to allow the movement of transition metal ions between the first electrode plate 111 and the second electrode plate 112. The separator 113 may be formed of polyethylene, polypropylene, or a composite film of polyethylene and polypropylene. However, the present disclosure is not limited with respect to the material of the separator 113.

The separator 113 may be formed to have a larger width and a larger length than the first electrode plate 111 and the second electrode plate 112 in both the first direction x and the second direction y to more reliably prevent short circuit between the first electrode plate 111 and the second electrode plate 112. In other words, the separator 113 may have a larger planar size than the first electrode plate 111 and the second electrode plate 112.

The separator 113 may be interposed between the negative electrode plate 111 and the positive electrode plate 112 to prevent electrical short-circuit between the negative electrode plate 111 and the positive electrode plate 112. In some embodiments, the separator 113 are provided in a pair, and the negative electrode plate 111 may be sandwiched between the pair of separators 113.

Depending on the type of lithium secondary battery, the separator may be present between a positive electrode and a negative electrode. As the separator, polyethylene, polypropylene, polyvinylidene fluoride, or a multilayer film of two or more layers thereof may be used.

The separator 113 may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

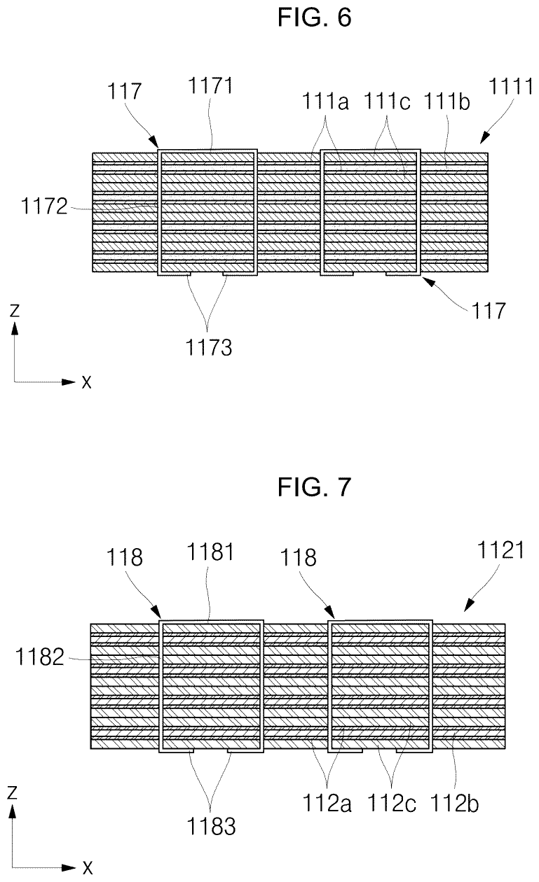

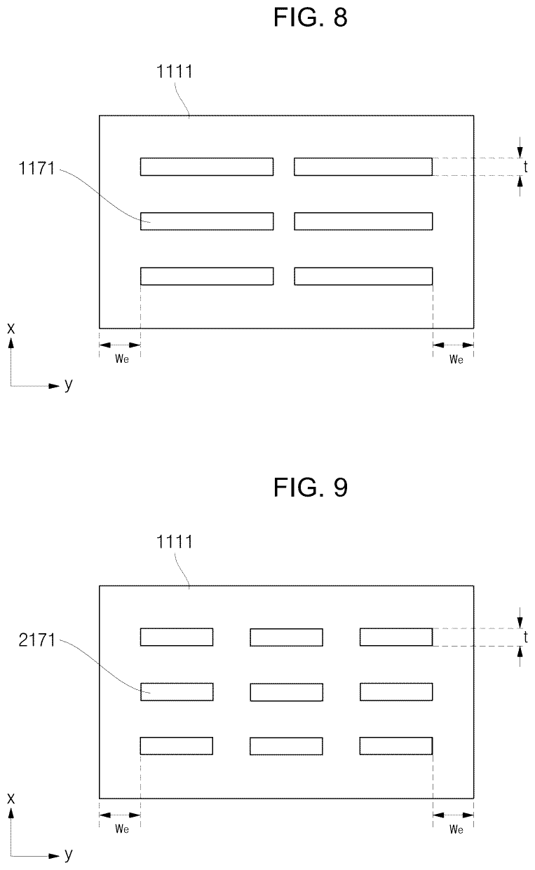

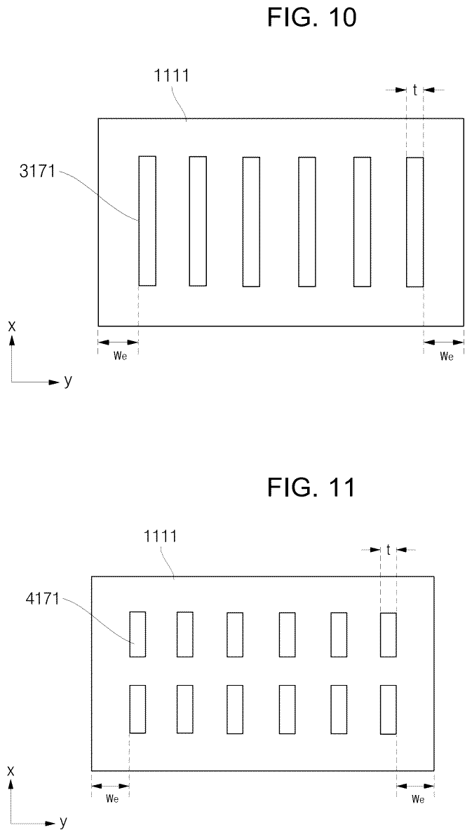

FIG. 6 is a schematic cross-sectional view illustrating an example of the negative electrode tab of the electrode assembly taken along line 6-6′ in FIG. 3, FIG. 7 is a schematic cross-sectional view illustrating an example of the positive electrode tab of the electrode assembly taken along line 7-7′ in FIG. 3, FIG. 8 is a plan view of a first embodiment of the negative electrode tab shown in FIG. 6, FIG. 9 is a plan view of a second embodiment of the negative electrode tab shown in FIG. 6, FIG. 10 is a plan view of a third embodiment of the negative electrode tab shown in FIG. 6, and FIG. 11 is a plan view of a fourth embodiment of the negative electrode tab shown in FIG. 6.

As described above, in an electrode plate in which the electrode insulating layer is embedded in the electrode metal layer, the overall thickness and weight thereof may be reduced, thereby improving specific energy of the secondary battery 100. However, due to the electrode insulating layer (e.g., PET), the electrode tabs may not be easily welded to each other. To address this issue, the present disclosure may employ a stapler-type physical joining method to effectively join the electrode tabs while allowing current to flow through the electrode tabs. The stapler-type joining method may use a staple made of a metal such as nickel and may physically join the substrates (the electrode tabs) multiple times, thereby reducing resistance and improving current delivery efficiency.

Hereinafter, a stapler-type joining structure will be described with reference to FIGS. 6 to 11.

Referring to FIG. 6, the first electrode tabs 1111 may be uncoated areas that are not coated with the first electrode active material, and the first electrode tabs 1111 may overlap each other in the third direction z (which is the height direction). In some embodiments, a first connection member 117 penetrates the first electrode tabs 1111 in the third direction z.

The first connection member 117 may penetrate the plurality of first electrode tabs 1111 to fix the first electrode tabs 1111 and enable efficient current flow. The first connection member 117 may maintain fixing force and secure electrical contact stability while penetrating the first electrode tabs 1111.

The first connection member 117 may penetrate the first electrode tabs 1111 from an upper surface of the uppermost first electrode tab to a lower surface of the lowermost first electrode tab, and the first connection member 117 may be secured to the lower surface of the lowermost first electrode tab. The first connection member 117 may be a C-shaped clip structure.

The first connection member 117 may include three main regions, which serve to optimize electrical contact reliability, penetration force, and fixing force. Specifically, the first connection member 117 may include a first region 1171, a second region 1172, and a third region 1173.

The first region 1171 may be located on the upper surface of the uppermost first electrode tab 1111. The first region 1171 may provide fixing force to the upper surface of the uppermost first electrode tab 1111.

The second region 1172 may be bent from the first region 1171 such that the second region 1172 extends from both sides of the first region 1171 and may extend through the first electrode tabs 1111 in the third direction z. The second region 1172 may be a core portion of the first connection member 117 that penetrates the first electrode tabs 1111 to physically join the first electrode tabs 1111. The second region 1172 may have high rigidity and durability and may provide enhanced electrical characteristics because current is concentrated thereon.

The third region 1173 may be bent from the second region 1172 such that the third region 1173 extends from the second region 1172, and the third region 1173 may be located on the lower surface of the lowermost first electrode tab 1111. The third region 1173, which is located on the lower surface of the lowermost first electrode tab 1111, may fully secure the first connection member 117 to the first electrode tabs 1111. The third region 1173 may be in contact with the lower surface of the lowermost first electrode tab 1111. The third region 1173 may be bent toward the center of the first connection member 117. More specifically, the third region 1173 may be bent toward the center of the first connection member 117, thereby increasing fixing force and enhancing contactability with the first electrode tabs.

In some embodiments, the first region 1171, the second region 1172, and the third region 1173 may each have a thickness t ranging from 0.2 mm to 0.5 mm. The thickness t may be such that electrical contact and mechanical strength requirements are met while minimizing load during penetration and bending processes and ensuring weight reduction and manufacturing efficiency. If the thickness t is less than 0.2 mm, the first connection member 117 may be deformed or damaged in the process of penetrating the first electrode tabs. If the thickness t exceeds 0.5 mm, penetration through the first electrode tabs 1111 may become difficult, contact resistance may increase, and weight reduction may not be sufficiently achieved.

In some embodiments, the first region 1171, the second region 1172, and the third region 1173 may have different thicknesses. For example, because the third region 1173 is a first portion that penetrates the first electrode tabs 1111 when assembling the structure, the third region 1173 may be thinner than the other regions. In another example, the thickness of the first connection member 117 may gradually decrease from the first region 1171 toward the third region 1173. The thickness of the first connection member 117 may be designed according to the material and thickness of the first electrode tabs 1111 to provide sufficient stiffness for penetrating the first electrode tabs 1111. For example, to facilitate penetration of a PET composite material of the first electrode tabs 1111, a distal end of the third region 1173 may be formed with a sharp profile to easily pierce the substrate while not interfering with electrical contact.

The first connection member 117 may be formed of at least one of nickel, copper, stainless steel, and silver. In some embodiments, the material of the first connection member 117 may be the same as that of the negative electrode. Materials having sufficient rigidity to penetrate the first electrode tabs 1111 may be used as the material of the first connection member 117.

Referring to FIG. 7, the second electrode tabs 1121 may be uncoated areas that are not coated with the second electrode active material, and the second electrode tabs 1121 may overlap each other in the third direction z (which is the height direction). In some embodiments, there may be provided a second connection member 118 that extends through the second electrode tabs 1121 in the third direction z.

The second connection member 118 may extend through the plurality of second electrode tabs 1121 to fix the second electrode tabs 1121 and enable efficient current flow. The second connection member 118 may maintain fixing force and secure electrical contact stability while penetrating the second electrode tabs 1121.

In some embodiments, the second connection member 118 may extend through the second electrode tabs 1121 from an upper surface of the uppermost second electrode tab to a lower surface of the lowermost second electrode tab, and the second connection member 118 may be secured to the lower surface of the lowermost second electrode tab. The second connection member 118 may have a C-shaped clip structure.

The second connection member 118 may include three main regions, which serve to optimize electrical contact reliability, penetration force, and fixing force. More specifically, the second connection member 118 may include a first region 1181, a second region 1182, and a third region 1183. The second connection member 118 may be made of at least one of aluminum, an aluminum alloy, a copper-aluminum alloy, and stainless steel. In some embodiments, the material of the second connection member 118 may be the same as that of the positive electrode. Materials having sufficient rigidity to penetrate the second electrode tabs 1121 may be used as the material of the second connection member 118.

The structure and configuration of the second connection member 118 may be the same as or similar to the first connection member 117, and, thus, a further description of the second connection member 118 will be omitted.

FIGS. 8 to 11 are plan views of the first electrode tabs 1111 provided with various embodiments of the first connection member. In FIGS. 8 to 11, the first regions 1171, 2171, 3171, and 4171 of the respective first connection members 1171, 2171, 3171, and 4171 are illustrated. Although only the first electrode tab 1111 is illustrated by way of example, the following description may also be applied to the second electrode tab 1121.

Referring to FIGS. 8 to 11, the first connection members 1171, 2171, 3171, or 4171 may be located in a central area of the length of the first electrode tab 1111 in the second direction y. In an example, each of both peripheral areas of the first electrode tab 1111, which are outside of the central area thereof, may have a width We of 1 mm or greater in the second direction y. If the width We of each of both peripheral areas of the first electrode tab 1111 in the second direction y is less than 1 mm, such that the first connection members 1171, 2171, 3171, or 4171 are closer to the sides of the first electrode tab 111, then stability may be degraded.

In some embodiments, the first connection member 1171, 2171, 3171, and/or 4171 may include a plurality of connection members. The plurality of first connection members 1171, 2171, 3171, and 4171 may be arranged in the first direction x of the first electrode tab 1111. In other embodiments, the plurality of first connection member 117, 217, 317, and 417 may be arranged in the second direction y of the first electrode tab 1111. In still further embodiments, the plurality of first connection members 1171, 2171, 3171, or 4171 may be arranged in the first direction x and the second direction y. For example, the first region of the first connection member 1171, 2171, 3171, or 4171 may be formed in a linear shape and may extend in the longitudinal direction x or the width direction y of the first electrode tab 1111 to meet design requirements. This configuration enables efficient use of space on the upper surface of the first electrode tab 1111 occupied by the first connection members 1171, 2171, 3171, and 4171 while securing joining strength by the first connection members 1171, 2171, 3171, and 4171.

Referring to FIGS. 8 and 9, the first regions of the first connection members 1171 and 2171 may have a linear shape extending in the second direction y of the first electrode tab 1111. As shown in FIG. 8, the first regions may be arranged in a 2×3 pattern. As shown in FIG. 9, the first regions may be arranged in a 3×3 pattern. However, the present disclosure is not limited to such examples, and the first regions of the first connection members 1171 and 2171 may be arranged in various other patterns.

Referring to FIGS. 10 and 11, the first regions of the first connection members 3171 and 4171 may have a linear shape extending in the first direction x of the first electrode tab 1111. As shown in FIG. 10, the first regions may be arranged in a 6×1 pattern. As shown in FIG. 11, the first regions may be arranged in a 6×2 pattern. However, the present disclosure is not limited to such configurations, and the first regions of the first connection members 3171 and 4171 may be arranged in various other patterns.

As described above, the first connection members 1171, 2171, 3171, or 4171 may include a plurality of connection members, and the plurality of connection members of the first connection members 1171, 2171, 3171, or 4171 may be arranged in the longitudinal direction x or the width direction y of the first electrode tab 1111. For example, for an electrode tab having a small width, the connection members may be arranged in the width direction to maximize current delivery within a minimal area. In another example, for an electrode tab having a large length, the connection members may be arranged in the longitudinal direction to provide uniform fixing force. Different arrangement patterns may be used during the manufacturing process and may be adaptable to various design conditions, thereby providing flexibility in the process and design.

In some embodiments, the plurality of first connection members 1171, 2171, 3171, and 4171 may be made of the same material and may have the same specifications. In other embodiments, the plurality of first connection members 117, 217, 317, and 417 may be made of different materials and may have different specifications. For example, the connection members disposed in the central area may be formed of a material having higher rigidity or may have an increased thickness to ensure enhanced joining strength.

The first connection member 117 may further include a cover member (not shown) that covers at least one of the first region 1171 and/or the third region 1173. The cover member may be attached to cover a sharp portion of the first connection member 117 and to prevent electrical short circuit. During the process in which the first connection member 117 penetrates and secures the first electrode tabs 1111, a sharp edge may be formed by bending or cutting. Such a sharp edge may cause physical damage to the separator or adjacent electrode tabs, which may in turn lead to electrical short circuit inside the battery. The cover member may cover the sharp portion of the first connection member 117 to prevent damage caused by physical contact, and the cover member may form an electrically insulating layer to block unintended current flow.

The cover member may be made of a material having excellent electrical insulation and thermal stability, such as polyimide (PI), polyethylene terephthalate (PET), or polypropylene (PP). These materials may ensure durability while maintaining stability even in high-temperature environments.

The cover member may be primarily applied to the third region 1173 and the first region 1171 of the first connection member 117, which have sharp portions. The cover member may be stably attached to the first connection member 117 and the first electrode tab 1111 via an adhesive or a thermoplastic bonding layer.

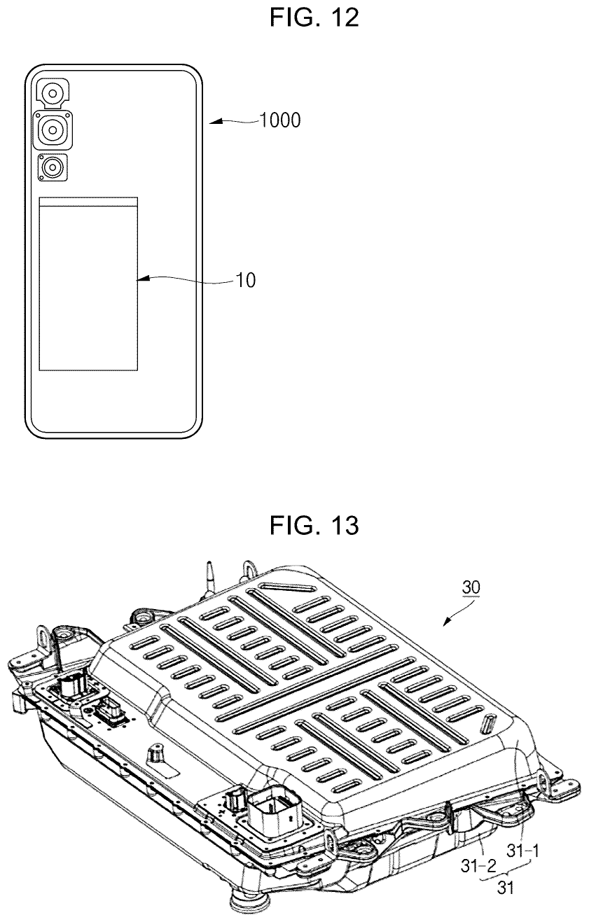

FIG. 12 is a view schematically showing a smartphone 1000 equipped with a secondary battery 10 according to an embodiment of the present disclosure. As shown in FIG. 12, a secondary battery 10 according to the above-described embodiment of the present disclosure may be a small battery mounted in a small portable device such as a smartphone 1000. In this case, because the exemplary secondary battery 10 is configured to be able to increase the capacity thereof while having a slim internal structure, the above-described secondary battery 10 may be a battery suitable for application to small portable devices. As used herein, the terms “secondary battery pack” and “battery” have the same meaning and are different only in expression for convenience of description.

In addition, the secondary battery 10 according to the above-described embodiment may consist of a single cell, but may be used to manufacture a battery pack including a plurality of cells or to manufacture a larger battery pack by increasing the sizes of the battery cells.

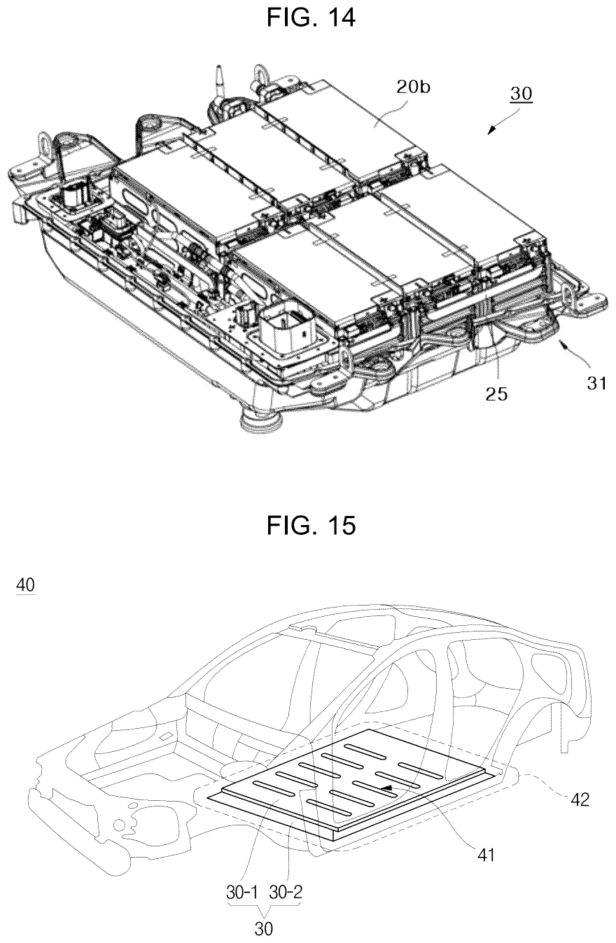

FIGS. 13 and 14 are perspective views showing an exemplary battery pack 30. The battery pack 30 may include a plurality of battery modules 20b and a housing 31 for accommodating the plurality of battery modules 20b. For example, the housing 31 may include first and second housings 31-1 and 31-2 coupled in opposite directions through the plurality of battery modules 20b. The plurality of battery modules 20b may be electrically connected to each other by using a bus bar 25-1, and the plurality of battery modules 20b may be electrically connected to each other in a series/parallel or series-parallel mixed method, thereby obtaining required electrical output.

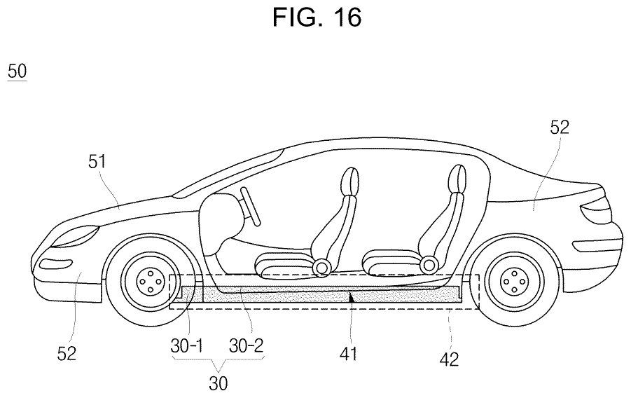

FIGS. 15 and 16 illustrate perspective and side views of examples of a vehicle body 40 and a vehicle components.

In FIG. 15, a battery pack 30 may include a battery pack cover 30-1, which is a part of a vehicle underbody 41, and a pack frame 30-2 located under the vehicle underbody 41. In some examples, the battery pack cover 30-1 may correspond to the first housing 31-1, and the pack frame 30-2 may correspond to the second housing 31-2. The pack frame 30-2 and the battery pack cover 30-1 may be integrally formed with a vehicle floor 42. The vehicle underbody 41 separates the inside and outside of a vehicle, and the pack frame 30-2 may be located outside the vehicle.

Referring to FIG. 16, a vehicle 50 may be formed by combining additional parts, such as a hood 51 in front of the vehicle and fenders 52 respectively located in the front and rear of the vehicle to a vehicle body 40. The vehicle 50 may include the battery pack 30 that include the battery pack cover 30-1 and the pack frame 30-2, and the battery pack 30 may be coupled to the vehicle body 40.

In a secondary battery according to the present disclosure, an insulating layer may be embedded in an electrode current collector of an electrode plate, thereby reducing the overall thickness and weight of the electrode plate and improving specific energy. Furthermore, a connection member may penetrate and secure a plurality of aligned electrode tabs, thereby enabling current flow through the electrode tabs and facilitating welding and joining of the electrode tabs.

However, the aspects and features of the present disclosure are not limited to those described above, and other aspects and features not expressly described herein will be clearly understood by a person skilled in the art from the description of example embodiments of the present disclosure described below.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

What is claimed is:

1. A secondary battery comprising:
a case; and
an electrode assembly accommodated in the case, the electrode assembly comprising a plurality of first electrode plates, separators, and a plurality of second electrode plates, with the first electrode plates and the second electrode plates being alternatively stack and one of the separators being positioned between each pair of first electrode plate and second electrode plate,
wherein each of the first electrode plates comprises:
an electrode current collector comprising a electrode insulating layer having a plate shape, an electrode metal layer provided on opposite surfaces of the electrode insulating layer, and an electrode tab protruding in a first direction from a side of the electrode current collector; and
an electrode active material provided on at least one surface of the electrode current collector,
wherein the electrode tabs areas of the electrode current collectors of the first electrode plates that are not coated with the first electrode active material,
wherein the electrode tabs are aligned with each other in a second direction that is perpendicular to the first direction, and
wherein a connection member extends through the first electrode tabs in the second direction.

2. The secondary battery as claimed in claim 1, wherein the connection member penetrates the electrode tabs from an upper surface of an uppermost electrode tab to a lower surface of a lowermost electrode tab, and at least a portion of the connection member is secured to the lower surface of the lowermost electrode tab.

3. The secondary battery as claimed in claim 1, wherein the connection member has a C-shaped clip structure.

4. The secondary battery as claimed in claim 1, wherein the connection member comprises:
a first region located on an upper surface of an uppermost electrode tab;
a second region that is bent from the first region and extends from opposite sides of the first region, with the second region extending through the first electrode tabs in the second direction; and
a third region that is bent and extends from the second region, with the third region being positioned on a lower surface of a lowermost electrode tab.

5. The secondary battery as claimed in claim 4, wherein the third region contacts the lower surface of the lowermost electrode tab.

6. The secondary battery as claimed in claim 4, wherein the third region is bent toward a center of the connection member.

7. The secondary battery as claimed in claim 4, wherein the first region has a linear shape extending in a third direction that is perpendicular to the first direction and the second direction.

8. The secondary battery as claimed in claim 4, wherein the first region has a linear shape extending in the first direction.

9. The secondary battery as claimed in claim 4, wherein the first region, the second region, and the third region each have a thickness of 0.2 mm to 0.5 mm.

10. The secondary battery as claimed in claim 4, wherein the first region, the second region, and the third region have different thicknesses.

11. The secondary battery as claimed in claim 1, wherein the connection member is positioned in a central area of a length of the first electrode tab in a third direction that is perpendicular to the first direction and the second direction, and
wherein peripheral areas of the first electrode tab outside of the central area have widths of 1 mm or greater in the third direction.

12. The secondary battery as claimed in claim 1, wherein the connection member comprises a plurality of connection members, and
wherein the connection members are arranged in the first direction.

13. The secondary battery as claimed in claim 1, wherein the connection member comprises a plurality of connection members, and
wherein the connection members are arranged in a third direction that is perpendicular to the first direction and the second direction.

14. The secondary battery as claimed in claim 1, wherein the connection member is formed of at least one of nickel, copper, stainless steel, and silver.

15. The secondary battery as claimed in claim 1, wherein the electrode metal layer, the electrode active material, and the electrode insulating layer are exposed at opposite sides of the first electrode plate.

16. The secondary battery as claimed in claim 1, wherein the electrode insulating layer comprises at least one of polyimide (PI), polyethylene terephthalate (PET), polypropylene (PP), polyethylene (PE), polystyrene (PS), acrylonitrile butadiene styrene (ABS), polyoxymethylene (POM), polyvinyl chloride (PVC), polycarbonate (PC), polycaprolactone (PCL), polylactic acid (PLA), acrylic resin, polybutylene terephthalate (PBT), celluloid, polytetrafluoroethylene (PTFE), Bakelite, epoxy, melamine-formaldehyde, amino, and phenol-formaldehyde.

17. The secondary battery as claimed in claim 4, further comprising a cover member configured to cover at least one of the first region or the third region of the connection member.

18. The secondary battery as claimed in claim 1, wherein the current collector is a first current collector, the electrode tab is a first electrode tab, and the electrode active material is a first electrode active material,
wherein each of the second electrode plates comprises:
a second electrode current collector comprising a second electrode tab extending and protruding in the first direction from a side of the second electrode current collector, and
a second electrode active material provided on at least one surface of the second electrode current collector,
wherein the second electrodes are areas of the second electrode current collectors that are not coated with the second electrode active material, and
wherein the first electrode tabs are spaced apart and electrically isolated from the second electrode tabs.

19. The secondary battery as claimed in claim 1, wherein the current collector is a first current collector, the electrode tab is a first electrode tab, and the electrode active material is a first electrode active material,
wherein each of the second electrode plates comprises:
a second electrode current collector formed as a plate-shaped metal foil and comprising a second electrode tab protruding in the first direction from a side of the second electrode current collector, and
a second electrode active material provided on at least one surface of the second electrode current collector,
wherein the second electrode tabs are uncoated areas of the second electrode current collectors that are not coated with the second electrode active material,
wherein the second electrode tabs are aligned with each other in the second direction, and
wherein the second electrode tabs are welded to each other.

20. The secondary battery as claimed in claim 1, wherein the current collector is a first current collector, the electrode tab is a first electrode tab, the insulating layer is a first electrode insulating layer, the electrode active material is a first electrode active material, and the connection member is a first connection member,
wherein each of the second electrode plates comprises:
a second electrode current collector comprising a second electrode insulating layer having a plate shape, a second electrode metal layer provided on opposite surfaces of the second electrode insulating layer, and a second electrode tab protruding in the first direction from a side of the second electrode current collector;
a second electrode active material provided on at least one surface of the second electrode current collector,
wherein the second electrode tabs are uncoated areas of the second electrode current collectors that are not coated with the second electrode active material, and the second electrode tabs are aligned with each other in the second direction; and
wherein a second connection member extends through the second electrode tabs.
